(19) United States
(12) Patent Application Publication
(10) Pub. No.: US 2010/0046248 A1
(43) Pub. Date: Feb. 25, 2010

(54) OPTIC FILM AND BACKLIGHT MODULE USING SAME

(76) Inventors: Chien-Chin MAI, Kaohsiung City (TW); Jui-Tang Yin, Kaohsiung City (TW); Yeong-Feng Wang, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/193,762

(22) Filed: Aug. 19, 2008

(51) Int. Cl. G02B 5/02; F21V 8/00; F21V 3/04

(52) U.S. Cl. 362/620; 359/599; 362/235

(57) ABSTRACT

An optic film includes a substrate and a condensation layer. The substrate has a light incidence surface and a light emission surface. The light incidence surface is treated to form a roughened frosted surface. The condensation layer is arranged on the light emission surface of the substrate and forms prism-like micro-structures. With the light incidence surface of the substrate being directly subjected to knurling or sand blasting to form the roughened frosted surface, when light enters the substrate through the light incidence surface, the light is diffused first by the frosted surface of the light incidence surface and is then subjected to condensation by the condensation layer, whereby when the optic film is applied to a backlight module, the optic film can effect both diffusion and condensation of light, so that the number of optic films used in the backlight module can be reduced.

### BACKGROUND OF THE INVENTION

(a) Technical Field of the Invention

The present invention relates to an optic film, and in particular to a structure that features both diffusion and condensation of light.

(b) Description of the Prior Art

A thin-film transistor liquid crystal display (TFT-LCD) comprises a light source that is provided by a backlight module. The backlight module must provide light of excellent uniformity and brightness in order to ensure excellent subsequent applications and uses.

The backlight module uses various numbers of optic films, which include a diffusion film for diffusion of light and a prism film that condenses light. The number and arrangement of the optic film can be varied as desired. The optic films, either the diffusion film or the prism film, have only a single function with respect to the light transmitting therethrough. Thus, a great number of optic films must be simultaneously used in order to achieve desired optic results. The optic films are often of high expenses and this makes the costs of the backlight module very high and also leads to troubles and problems associated with complicated inventory of pails.

A light condensation film is available in the market. As shown in FIG. 1 of the attached drawings, the known light condensation film 1 includes a substrate 11 and a plurality of prisms 12. The prisms 12 are lined up on a surface of the substrate 11. The substrate 11 further comprises a diffusion layer 13 formed on the underside thereof. The diffusion layer 13 is formed by well stirring a resin 131 in which diffusion beads 132 are mixed. Since the diffusion layer 13 contains the diffusion beads 132 therein, when the diffusion layer 13 is coated on the underside of the substrate 11, the diffusion layer 13 that diffuses light is provided on the underside of the substrate 11.

As shown in FIG. 2, when light passes through the diffusion layer 13 for emitting outwards, diffusion of the light occurs. Since the diffusion beads 132 are naturally formed light-transmitting spheres, they can, after condensing light, causes light to be diffused.

Such a structure of the conventional light condensation film 1 can realize both diffusion and condensation of light. Although the total number of optic films used can be reduced, yet the diffusion layer 13 of the light condensation film 1 must be separately coated on the underside of the substrate 11 after the resin 131 is mixed with the diffusion beads 132 and it cannot be used until the resin cures. This complicates the manufacturing process and also increases the material costs.

In view of the above discussed drawbacks of the conventional light condensation film 1, the electro-optic industry is facing a challenge of developing an optic film that features both diffusion and condensation of light.

### SUMMARY OF THE INVENTION

The primary purpose of the present invention is to overcome the drawback of the conventional optic film that employs a complicated process and requires increased material expenses by using a diffusion layer formed by coating a resin in which diffusion beads are mixed and well stirred on an underside of a substrate to realize both diffusion and condensation of light.

Thus, an objective of the present invention is to provide an optic film that comprises a substrate and a condensation layer. The substrate has a light incidence surface and a light emission surface. The light incidence surface is treated by knurling or sand blasting to form a roughened frosted surface. The condensation layer is arranged on the light emission surface of the substrate and forms prism-like micro-structures. With the light incidence surface of the substrate being directly subjected to knurling or sand blasting to form the roughened frosted surface, when light enters the substrate through the light incidence surface, the light is diffused first and is then subjected to condensation by the condensation layer, whereby the optic film realizes both diffusion and condensation of light.

Another objective of the present invention is to provide an optic film that comprises a substrate and a condensation layer. The substrate has a light incidence surface and a light emission surface. The light incidence surface and the light emission surface of the substrate are both treated by knurling or sand blasting to form a roughened frosted surface. With the light emission surface of the substrate being treated to form a roughened frosted surface, when the condensation layer is positioned on the light emission surface, the bonding force between the condensation layer and the substrate can be enhanced, and light is subjected to secondary diffusion by the frosted surface of the light emission surface before the light is condensed by the condensation layer and leaving the optic film.

A further objective of the present invention is to provide an optic film that comprises a substrate, which has a light incidence surface and a light emission surface. The light incidence surface is treated by knurling or sand blasting to form a roughened frosted surface. The light emission surface of the substrate forms prism-like micro-structures thereon. When light enters the substrate through the light incidence surface, the light is diffused first and is then subjected to condensation by the micro-structures of the light emission surface, whereby the optic film realizes both diffusion and condensation of light.

Yet a further objective of the present invention is to provide a backlight module, in which the optic film described above is embodied. With the light incidence surface of the substrate being subjected to knurling or sand blasting to form a roughened frosted surface and further with a condensation layer arranged on the light emission surface of the substrate, since the condensation layer has prism-like micro-structures and since the light incidence surface of the substrate is treated by knurling or sand blasting to form the roughened frosted surface, when light enters the substrate through the light incidence surface, the light is diffused first and is then subjected to condensation by the condensation layer, whereby the optic film realizes both diffusion and condensation of light so that the number of optic films used in the backlight module can be reduced and excellent uniformity and brightness of light can be ensured for the light source of the backlight module.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is schematic view illustrating a conventional optic film;

FIG. 2 is a schematic view illustrating light transmitting through the conventional optic film;

FIG. 3 is a schematic view illustrating an optic film constructed in accordance with the present invention;

FIG. 4 is a schematic view illustrating light transmitting through the optic film of the present invention;

FIG. 5 is a schematic view illustrating an optic film constructed in accordance with another embodiment of the present invention;

FIG. 6 is a schematic view illustrating an optic film constructed in accordance with a further embodiment of the present invention;

FIG. 7 is a schematic view illustrating an application of the optic film of the present invention in a side-edge type backlight module; and

FIG. 8 is a schematic view illustrating an application of the optic film of the present invention in a direct type backlight module.

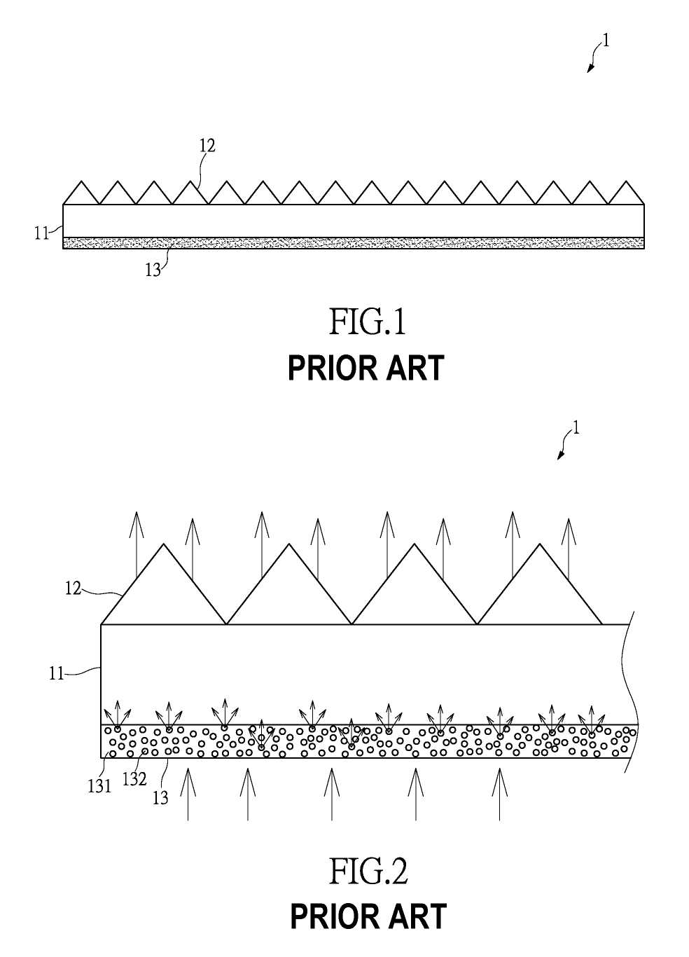

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

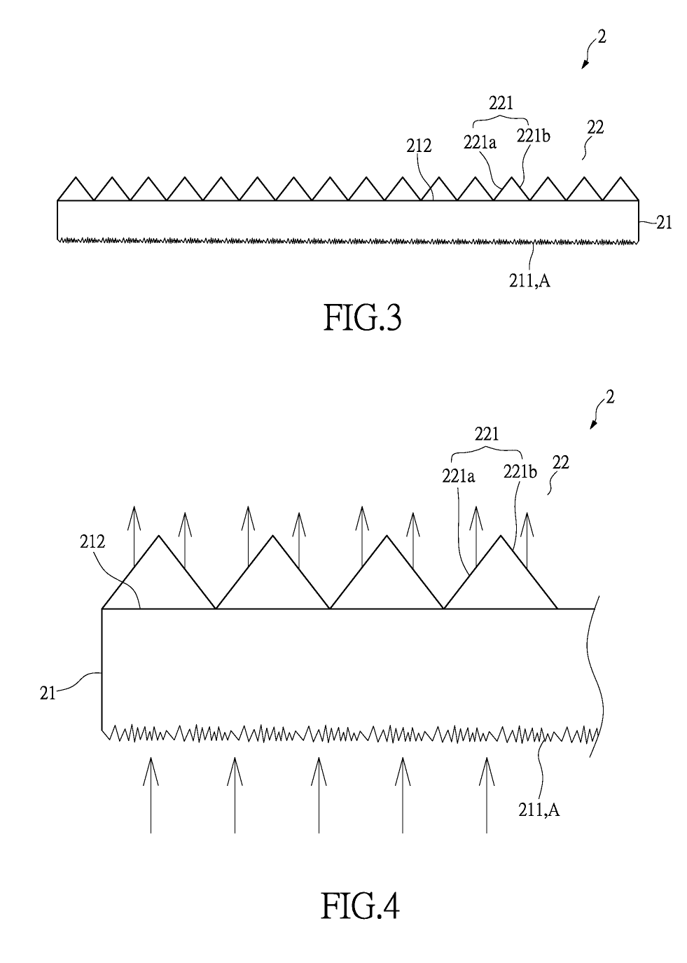

With reference to the drawings and in particular to FIG. 3, an optic film constructed in accordance with the present invention, generally designated with reference numeral 2, comprises a substrate 21 and a condensation layer 22.

The substrate 21 is made of a high-molecule material, such as polycarbonate (PC), polyethylene terephthalate (PET) and polymethyl methacrylate (PMMA). The substrate 21 has a light incidence surface 211 and a light emission surface 212, wherein the light incidence surface 211 is treated by means of knurling or sand blasting to form a roughened frosted surface A.

The condensation layer 22 can be made of a material that is similar to that of the substrate 21, such as PC, PET, and PMMA, or the condensation layer 22 can be made of a material different from that of the substrate 21. The condensation layer 22 is arranged on the light emission surface 212 of the substrate 21 in such a way that the condensation layer 22 comprises a plurality of prism-like micro-structures 221 distributed on the light emission surface 212 of the substrate 21. The micro-structure 221 includes a first planar surface 221a and a second planar surface 221b. The first surface 221a and the second surface 221b can cause internal reflection of light inside the prism to have the light condensed so that when the light emits outward, condensation of the light can be resulted.

Referring now to FIG. 4, in an application of the optic film 2 in accordance with the present invention, when light enters the optic film 2, the light passes through the light incidence surface 211 of the optic film 2 and is diffused by the roughened frosted surface A. The light then emits through the light emission surface 212 of the substrate 21 and is subjected to condensation by the prism-like micro-structures 221 of the condensation layer 22.

Referring to FIG. 5, to practice the optic film 2 of the present invention, the light emission surface 212 of the substrate 21 can be further subjected to knurling, sand blasting or other treatments to form a roughened frosted surface B and the light emission surface 212 is then coated with a material that is similar to or different from that of the substrate 21, such as PC. PET, and PMMA, and is further processed to form the condensation layer 22 that comprises a plurality of prism-like micro-structures 221. By means of he roughened frosted surface B of the light emission surface 212, friction between the condensation layer 22 and the substrate 21 is enhanced, which improves the bonding between the condensation layer 22 and the substrate 21. Further, when light is emitted, the frost surface B of the light emission surface 212 causes secondary diffusion of the light, which light is then condensed by the condensation layer 22 before eventually emitted outward.

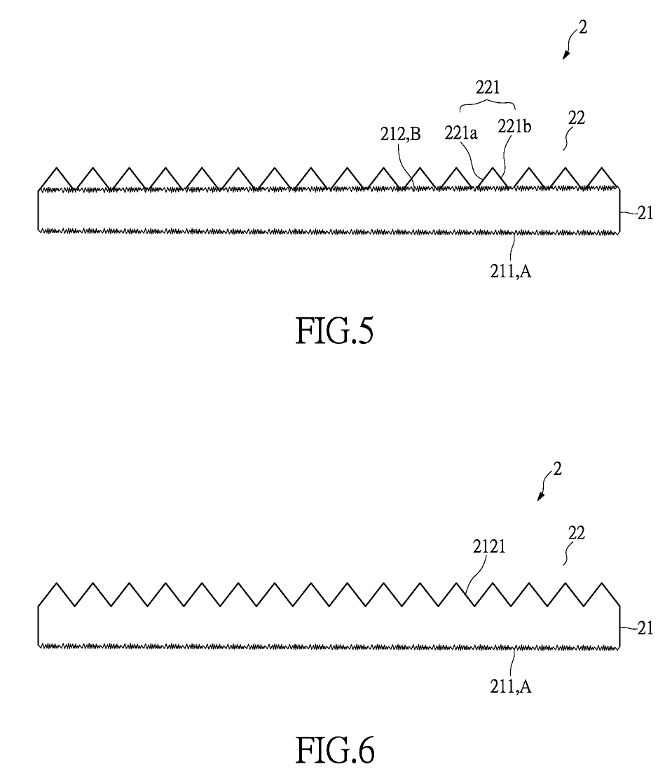

Also referring to FIG. 6, in practicing the optic film 2 of the present invention, it is feasible to directly for m prism-like micro-structures 2121 on the light emission surface 212 of the substrate 21. When light enters the substrate 21 through the light incidence surface 211, the light is subjected to diffusion by the frosted surface A of the light incidence surface 211 and then condensed by the micro-structures 2121 of the light emission surface 212. This similarly provides the optic film 2 with the effectiveness of both diffusion and condensation of light.

With the light emission surface 212 of the substrate 21 being planar, the roughness of the frosted surface A of the light incidence surface 211 of the substrate 21 is preferably between 5-90%, whereby when detected under the condition that the condensation layer 22 is removed (by removing or filling flat the micro-structures 221 of the 22), the substrate 21 of the present invention has a light permeability of around 75-96%.

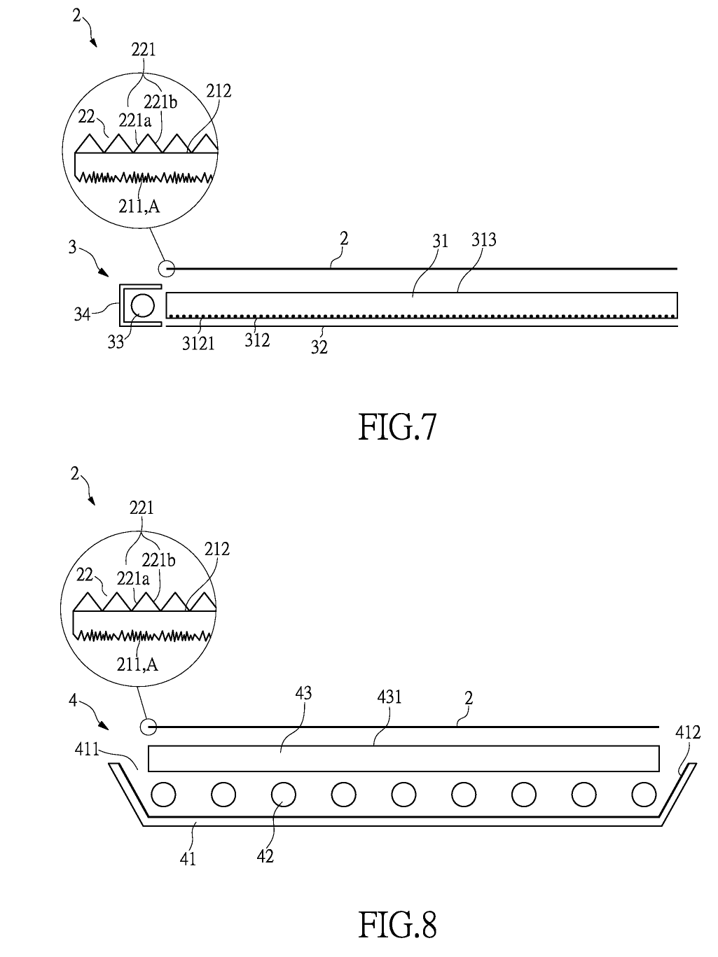

Referring to FIG. 7, which shows a schematic view illustrating an application of the optic film 2 of the present invention in a side-edge type backlight module 3, the side-edge type backlight module 3 comprises a light guide board 31, which has at least one light incidence surface 311, a reflection surface 312, and a light emission surface 313. The reflection surface 312 forms light guide patterns 3121. A reflector board 32 is arranged outside the reflection surface 312. Alight source 33 is arranged on the side of the light incidence surface 311. The light source 33 can be for example a cold cathode fluorescent lamp or a light-emitting diode, which is enclosed by a light reflector 34. The optic film 2 of the present invention is arranged on the light emission surface 313 of the light guide board 31 and the number of the optic film 2 used here can be a single film or more than one film, or alternatively, one or more than one diffusion films or condensation films can be further added above or under the optic film 2. With the roughened frosted surface A that is formed by knurling or sand blasting on the light incidence surface 211 of the substrate 21 of the optic film 2, and further with the condensation layer 22 that comprises prism-like micro-structures 221 arranged on the light emission surface 212 of the substrate 21, when the light from the light source 33 of the side-edge type backlight module 3 enters the light guide board 31 through the light incidence surface 311 of the light guide board 31 and then emits through the light emission surface 313 of the light guide board 31, and further enters the substrate 21 through the light incidence surface 211 of the substrate 21 of the optic film 2, the light is first diffused by the frosted surface A of the substrate 21 and then subjected to condensation by the condensation layer 22. As such, the optic film 2 can provide both diffusion and condensation of the light, whereby the number of the optic film 2 used in the side-edge type backlight module 3 can be reduced and uniformity and brightness of the light induced in the side-edge type backlight module 3 can be enhanced.

Referring to FIG. 8, which shows a schematic view illustrating an application of the optic film 2 of the present invention in a direct type backlight module 4, the direct type backlight module 4 comprises at least one case 41, a plurality of light sources 42, and a diffusion board 43. The case 41 forms, on a top thereof, an opening 411, which is convergent in a direction toward a bottom of the case 41. An internal surface of the case 41 is treated to form a shining surface or is provide with a reflection film 412 so that the case 41 can induce reflection of light therein. On the bottom inside the case 41, the light sources 42 are provided. The light sources 42 can be for example cold cathode fluorescent lamps or light-emitting diodes. The diffusion board 43 is arranged above the light sources 42 and covers the opening 411 of the case 41. The diffusion board 43 functions to make the light from the light sources 42 uniform and can be realized by containing therein diffusion agent or diffusion beads to effect diffusion of light. The diffusion board 43 has a top, light emission surface 431 on and outside which the optic film 2 of the present invention is arranged. The number of the optic film 2 used here can be a single film or more than one film, or alternatively, one or more than one diffusion films or condensation films can be further added above or under the optic film 2. With the roughened frosted surface A that is formed by knurling or sand blasting on the light incidence surface 211 of the substrate 21 of the optic film 2, and further with the condensation layer 22 that comprises prism-like micro-structures 221 arranged on the light emission surface 212 of the substrate 21, when the light from the light sources 42 of the direct type backlight module 4 enters the diffusion board 43 from below the diffusion board 43 and leaves the diffusion board 43 through the light emission surface 431, and further enters the substrate 21 through the light incidence surface 211 of the substrate 21 of the optic film 2, the light is first diffused by the frosted surface A of the substrate 21 and then subjected to condensation by the condensation layer 22. As such, the optic film 2 can provide both diffusion and condensation of the light, whereby the number of the optic film 2 used in the direct type backlight module 4 can be reduced for cutting down costs and uniformity and brightness of the light induced in the direct type backlight module 4 can be enhanced.

The effectiveness of the present invention is that the light incidence surface 211 of the substrate 21 of the optic film 2 forms a frosted surface A and a condensation layer 22 is arranged on the light emission surface 212 of the substrate 21, whereby when light transmits through the optic film 2, the light is first subjected to diffusion by the frosted surface A and then subjected to condensation by the condensation layer 22. Thus, the optic film 2 can achieve both diffusion and condensation of light and makes it possible to reduce the multiple optic films that are conventionally required to a single optic film 2. With the reduction of the number of the optic films used, the light can travel along the shortest path with the least loss and thus the objective of the present invention for reducing costs can be realized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optic film comprising a substrate and a condensation layer, the substrate having a light incidence surface and a light emission surface, the condensation layer arranged on the light emission surface of the substrate and forming prism-like micro-structures, wherein the light incidence surface of the substrate is roughened to form a frosted surface, which, when measured under the condition that the light emission surface of the substrate is planar, exhibits a roughness between 5-90%, whereby the substrate of the optic film exhibits light permeability of 75-96% with the condensation layer removed.

2. The optic film as claimed in claim 1, wherein the substrate and the condensation layer are made of identical material.

3. The optic film as claimed in claim 1, wherein the light emission surface of the substrate is roughened to form a frosted surface.

4. The optic film as claimed in claim 1, wherein the micro-structures are directly formed on the light emission surface of the substrate.

5. A side-edge type backlight module comprising:
a light guide board having at least a light incidence surface, a reflection surface, and a light emission surface;
a reflector board arranged outside the reflection surface of the light guide board;
a light source arranged by the light incidence surface of the light guide board;
a light reflector enclosing the light source; and
at least one optic film, and
characterized in that the optic film comprises a substrate and a condensation layer, the substrate having a light incidence surface and a light emission surface, the condensation layer arranged on the light emission surface of the substrate and forming prism-like micro-structures, wherein the light incidence surface of the substrate is roughened to form a frosted surface, which, when measured under the condition that the light emission surface of the substrate is planar, exhibits a roughness between 5-90%, whereby the substrate of the optic film exhibits light permeability of 75-96% with the condensation layer removed.

6. The side-edge type backlight module as claimed in claim 5, wherein the substrate and the condensation layer are made of identical material.

7. The side-edge type backlight module as claimed in claim 5, wherein the light emission surface of the substrate is roughened to form a frosted surface.

8. The side-edge type backlight module as claimed in claim 5, wherein the micro-structures are directly formed on the light emission surface of the substrate.

9. The side-edge type backlight module as claimed in claim 5, wherein the light source comprises a cold cathode fluorescent lamp.

10. The side-edge type backlight module as claimed in claim 5, wherein the light source comprises a light-emitting diode.

11. The side-edge type backlight module as claimed in claim 5 further comprising at least one diffusion film arranged outside the light emission surface of the light guide board.

12. The side-edge type backlight module as claimed in claim 11, wherein the diffusion film is arranged above or under the optic film.

13. The side-edge type backlight module as claimed in claim 5 further comprising at least one condensation film arranged outside the light emission surface of the light guide board.

14. The side-edge type backlight module as claimed in claim 13, wherein the condensation film is arranged above or under the optic film.

15. A direct type backlight module comprising:
a case, which forms an opening on a top thereof, the case having an internal surface that is made shinning or includes a reflection film attached thereto;
a plurality of light sources arranged on a bottom of the case;
a diffusion board arranged above the light sources and covering the opening; and
at least one optic film, and
characterized in that the optic film comprises a substrate and a condensation layer, the substrate having a light incidence surface and a light emission surface, the condensation layer arranged on the light emission surface of the substrate and forming prism-like micro-structures, wherein the light incidence surface of the substrate is roughened to form a frosted surface, which, when measured under the condition that the light emission surface of the substrate is planar, exhibits a roughness between 5-90%, whereby the substrate of the optic film exhibits light permeability of 75-96% with the condensation layer removed.

16. The direct type backlight module as claimed in claim 15, wherein the substrate and the condensation layer are made of identical material.

17. The direct type backlight module as claimed in claim 15, wherein the light emission surface of the substrate is roughened to form a frosted surface.

18. The direct type backlight module as claimed in claim 15, wherein the micro-structures are directly formed on the light emission surface of the substrate.

19. The direct type backlight module as claimed in claim 15, wherein the light sources comprise cold cathode fluorescent lamps.

20. The direct type backlight module as claimed in claim 15, wherein the light sources comprise light-emitting diodes.

21. The direct type backlight module as claimed in claim 15 further comprising at least one diffusion film arranged outside the light emission surface of the light guide board.

22. The direct type backlight module as claimed in claim 21, wherein the diffusion film is arranged above or under the optic film.

23. The direct type backlight module as claimed in claim 15 further comprising at least one condensation film arranged outside the light emission surface of the light guide board.

24. The direct type backlight module as claimed in claim 23, wherein the condensation film is arranged above or under the optic film.
